(19) United States
(12) Patent Application Publication
(10) Pub. No.: US 2022/0129959 A1
(43) Pub. Date: Apr. 28, 2022

(54) CENTRALIZED ELECTRONIC INVOICE SYSTEM

(71) Applicant: Jason Mayra, Hancock, MI (US)

(72) Inventor: Jason Mayra, Hancock, MI (US)

(21) Appl. No.: 17/083,231

(22) Filed: Oct. 28, 2020

(51) Int. Cl. G06Q 30/04; G06Q 20/38; G06Q 20/04; G06F 16/11; G06Q 20/10; G06Q 20/08; G06Q 40/02; G06Q 40/00

(52) U.S. Cl. CPC G06Q 30/04; G06Q 20/38215; G06Q 20/0425; G06Q 20/389; G06Q 20/108; G06Q 20/102; G06Q 20/085; G06Q 40/02; G06Q 40/12; G06F 16/113

(57) ABSTRACT

An illustrated view of an exemplary centralized electronic invoice/payment system for providing efficiency of invoicing and payment is presented. The centralized electronic invoice/payment system is useful for conveniently receiving all invoices in a timely manner and in one location for review. The centralized electronic invoice/payment system is useful for eliminating redundancy of invoice payments by paying multiple invoices with a single click. The centralized electronic invoice/payment system is further useful for retaining electronic proof of payment indefinitely.

### FIELD OF THE INVENTION

This invention relates to electronic invoice systems. More particularly, it relates to centralizing an electronic invoice system.

### BACKGROUND

Electronic billing or electronic bill payment and presentment is when a seller such as company, organization, or group sends its bills or invoices over the internet, and customers pay the bills electronically. This replaces the traditional method where invoices were sent in paper form and payments were done by manual means such as sending checks.

There are a number of advantages to electronic billing that include the faster presentation of invoices and reductions in costs in handling paper document. However, to take full advantage of electronic billing both seller and buyer need to have in place computer systems able to handle electronic billing and have access to financial institutions that have the capabilities for electronic payments.

Types of electronic billing systems are:

Biller-direct—where consumers make payments directly to one biller that issues bills that they receive at the website of the firm that issued the bill. An example would be of a public utility company offering this payment service to its consumers. A market has emerged for outsourced billing providers who specialize in electronic billing processes and technology for companies that need to send bills directly to their customers.

Bank-aggregator—where a payment is made at an aggregator or consolidator site, usually from a consumer's bank website. This model allows the consumer to make payments to multiple billers that are pre-registered to receive payments.

Billers, bankers, aggregators and consolidators can play various roles in the overall process. Once roles are defined, it is easier to identify which model is most appropriate for the client's strategy. Billers may also implement more than one model in order to best serve their clients. Because the industry is continuously changing and redefining, the options and opportunities will continue to expand.

Biller payment provider (BPP)—An agent of the biller that accepts remittance information on behalf of the Biller.

Biller service provider (BSP)—An agent of the biller that provides the service for the Biller.

Consolidator—A biller service provider that consolidates bills from multiple Billers or other bill service providers (BSPs) and delivers them for presentment to the customer service provider (CSP).

Customer service provider (CSP)—An agent of the customer that provides an interface directly to customers, businesses or others for bill presentment. CSP enrolls customers, enables presentment and provides customer care, among other functions.

Financial institutions typically formally prohibit the use of their consumer electronic bill payment systems for payments to certain agencies such as: collection agencies, or recipients of court-ordered payments like child support or alimony. Any organizations or individuals outside of the United States are also usually excluded. Payments to government agencies for utilities such as water are usually permitted.

Electronic bill pay systems fall into two categories, “pay-anyone” services and restricted biller list services. In a pay-anyone service, the provider will facilitate a payment to the payee regardless of whether they have an electronic connection with that payee or not. If they cannot deliver the payment to the payee electronically, they will print and mail a paper check on the payer's behalf. The largest providers of electronic bill pay services can deliver about 80% of their payments electronically, so 20% of payments facilitated by the large pay-anyone services are still made by mailing a paper check to the biller. This is the primary reason why some billers in a pay-anyone service require as much as a 5-day lead time for the payment to reach the payee.

Restricted biller list payment services allow you to pay any biller that is in the provider's network, and in these services where the provider has an electronic relationship with the biller, the payments will be delivered electronically.

Currently, invoices/payment requests are received in various forms and methods depending on the vendor. When paid, proof of payment k not conveniently accessible. Invoices are received electronically in more than one location, paid individually, and proof of payment is archived in more than one location for future reference.

Accordingly, and in light of the foregoing, there is a need for a system to centrally receive electronic invoices/payment requests and the ability to select and process a batch or pending invoices for payment with a single click. Further, there is a need for the once paid, invoices re-archived using a predetermined filing system for proof of payment and other functions.

### BRIEF DESCRIPTION OF THE DRAWINGS

FIG. 1 is an illustrated view of an exemplary centralized electronic invoice/payment system.

FIG. 2 is an exemplary flowchart for the centralized electronic invoice/payment system shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

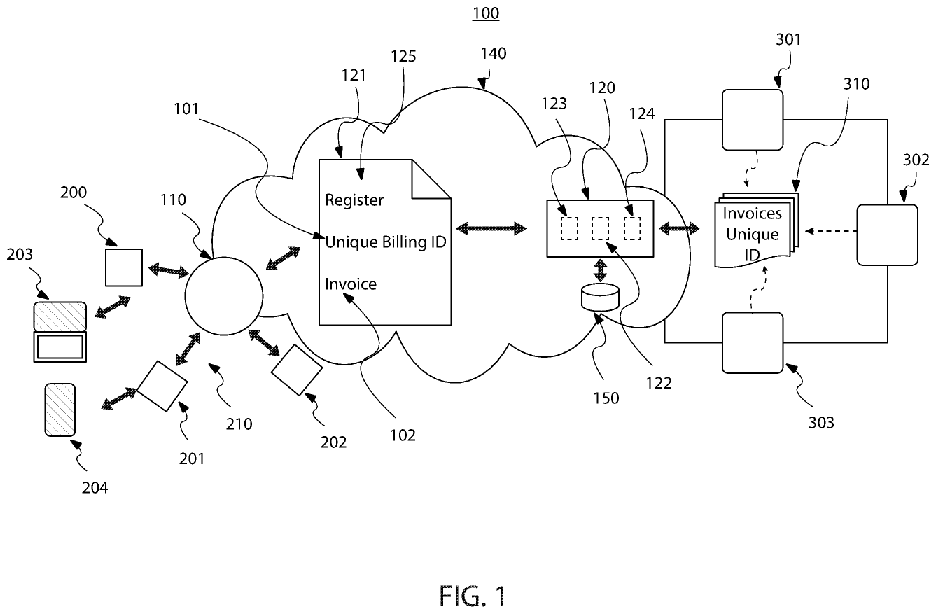

Referring to FIG. 1, an illustrated view of an exemplary centralized electronic invoice/payment system 100 for providing efficiency of invoicing and payment is presented. The centralized electronic invoice/payment system 100 is useful for conveniently receiving all invoices timely and in one location for review. The centralized electronic invoice/payment system 100 is useful for eliminating redundancy of invoice payments by paying multiple invoices with a single click. The centralized electronic invoice/payment system 100 is further useful for retaining electronic proof of payment indefinitely.

The centralized electronic invoice/payment system 100 has a user interface 110, a backend server 120, a communication path 140 and a storage apparatus 150. The backend server 120 has computer software 121, a hard disk drive 122, a central processing unit (CPU) 123 and a communication device 124.

One or more service providers use a computing device 200, 201, 202 to access a first internet network 210. The computing devices 200, 201, 202 access a software package 125 installed on the computing devices 200, 201, 202 or navigate to a website to access a portal into a billing system to submit invoices for services rendered. The computing devices 200, 201, 202 can be any device which allows the service providers to access the centralized invoice/payment system 100. The computing devices 200, 201, 202 are preferably laptop computers 203, however other electronic means are hereby contemplated, including, but not limited to, smart phones 204, tablets, desktop computers, etc.

The service providers, once the software package 125 has been activated, login into the backend service 120 of the centralized electronic invoice/payment system 100. The backend service 120 receives the login credentials of the service provider and assigns a unique identifier 101 to each service provider.

The CPU 123 receives the login information and credentials and invoice information. The invoice information including, but not limited to, payment methods, charges for payment, merchant, etc. The CPU 123 stores login information, unique identifier 101, invoice 102 and credentials, with a timestamp, with all other previously stored login information, credentials and invoice information 310 at the storage apparatus 150.

The invoice information and unique identifier are stored by the CPU 123 at the storage apparatus 150 in which the merchants may access to see all outstanding invoice information and aggregate the invoice information to be paid at a single time.

The CPU 123 then directs the invoice information with the unique identifier to a specified merchant 300, 301, 302 on the invoice information for scheduling for payment by storing the login information at the storage apparatus 150 for access of the invoices applying to each of the merchants 300, 301, 302 and aggregating the invoice information 310 for ease of review and processing. All previous and the current invoice information is captured and calculated together to remit one payment, thus one check or wire transfer, to the service provider eliminating overhead and costs with multiple payments to a single service provider.

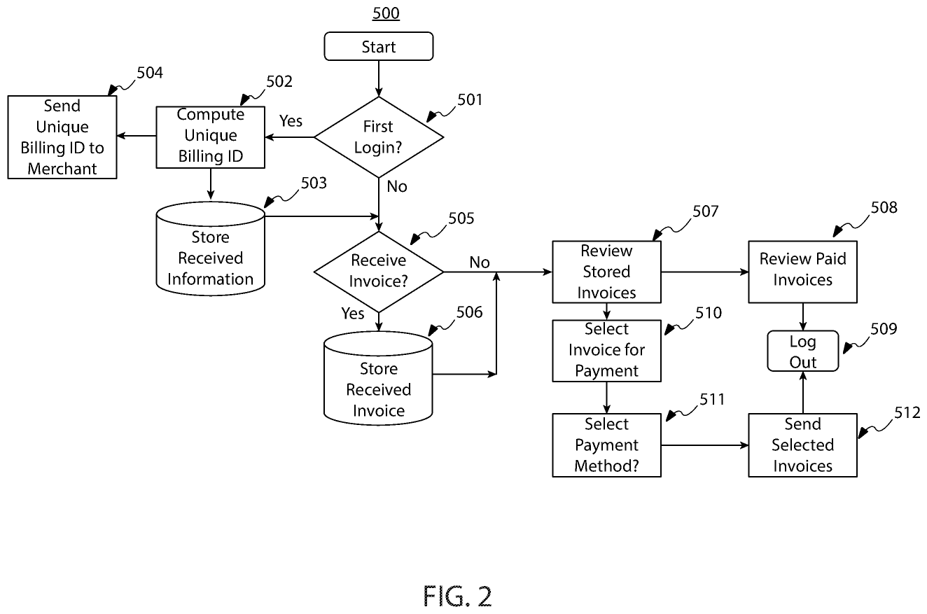

Moving now to FIG. 2, an exemplary flowchart 500 for the centralized electronic invoice/payment system 100 shown in FIG. 1 is presented.

Prior to the activity of the flowchart 500, one of the service providers accesses a computing device 200, 201, 202 and logs into the software package 125 for accessing a user interface of the centralized invoice/payment system 100.

At 501, if the service provider is a new user to the system, then upon verifying credentials, the backend server 120 obtains a unique identifier 101 for the service provider, at 502, and stores the unique identifier 101 at the storage apparatus 150 at 503.

At 504, the backend server 120 utilizes the communication device 124 to send the unique billing identifier to the merchants 300, 301, 302.

At 505, it is determined if an invoice 102 is also included by the service provider. If an invoice 102 is included by the service provider, then the invoice 102 is stored with the unique billing identifier 101 at the storage apparatus 150.

At 507, if an invoice 102 is not received, at 505, or after the received invoice 102 has been stored at the storage apparatus 150, at 506, the service provider accesses the storage apparatus 150 to review stored invoices 125 associated with their unique billing identifier 101.

At 508, the stored invoices 102 may be reviewed to see a payment history or to check on a status of a particular invoice 125 or invoices. If the user has completed their activity, then they may log out at 509.

When reviewing the stored invoices 125 at the storage apparatus 150, the user may select one or more of the invoices 125 to be processed for payment, at 510. At 511 after selecting the invoices for payment, at 510, the user then selects either a default payment method or may specify or select a predetermined payment method, such as by bank check, bank wire transfer, etc.

Once the payment method has been selected at 511, at 512, the selected invoices 102 are sent to the merchants 300, 301, 302 for payment. Once the user has completed all of the tasks they have set forth, then the user logs out at 509.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing centralized invoice payments, the method comprising:
receiving a new login at a backend server;
computing a unique billing identifier for the new login;
reviewing one or more invoices;
selecting one or more invoices from the reviewed invoices for payment;
selecting a payment method for use;
processing the selected invoices for payment; and
navigating archives to retrieve proof of payment after the selected invoices have been paid.

2. The method of claim 1, wherein computing a unique billing identifier further comprising storing the unique billing identifier at a storage apparatus.

3. The method of claim 1, wherein computing a unique billing identifier further comprising: sending the unique billing identifier to a logged in user.

4. The method of claim 1, wherein computing a unique billing identifier further comprising: sending the unique billing identifier to a merchant.

5. The method of claim 1, wherein the payment method being a default payment method.

6. The method of claim 1, wherein the payment method being updated to a second payment method.

7. The method of claim 1, wherein the selected invoices being an aggregate of more than one invoice.

8. The method of claim 1, wherein the method further comprising:
inputting a new invoice.

9. The method of claim 8, wherein the new invoice having the unique billing identifier.

10. The method of claim 8, wherein the new invoice being stored at the storage apparatus.

11. The method of claim 1, wherein the payment method being a bank check.

12. The method of claim 1, wherein the payment method being a bank wire transfer.
